(19) United States
(12) Patent Application Publication
(10) Pub. No.: US 2010/0172275 A1
(43) Pub. Date: Jul. 8, 2010

(54) Energy Efficient Device Discovery with Short-Range Radios

(75) Inventors: Haitao Wu, Beijing (CN); Kun Tan, Beijing (CN); Yongguang Zhang, Beijing (CN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/349,528

(22) Filed: Jan. 7, 2009

(51) Int. Cl. G08C 17/00

(52) U.S. Cl. 370/311

(57) ABSTRACT

Described is a technology in which a Wi-Fi enabled mobile computing device conserves power by only attempting peer discovery at certain times, according to a wakeup pattern. A device time clock is synchronized, such as via a cellular service, a GPS system, or a network to establish the time to awaken. Imprecise synchronization between the devices within a maximum difference is acceptable because the pattern ensures that any two devices are concurrently awake for at least a sufficient time to perform discovery. The awake time may be divided into active and inactive slots, arranged such that an active slot of each device will overlap regardless of when the awake time begins on each device. Also described is using a previously agreed-upon communications channel for subsequent discovery, which may be based upon pseudo-random number generation.

### BACKGROUND

Almost all modern laptop computers, as well as more and more mobile telephones, are now being built with a Wi-Fi NIC (network interface card) to provide user easy connectivity through widely deployed wireless local area networks (WLAN). WLANs exist as Wi-Fi hotspots, enterprise Wi-Fi networks, home Wi-Fi networks, and other networks.

IEEE 802.11 is the technology standard for WLAN (Wireless LAN), which has been widely used for both infrastructure and ad hoc networks. There are two network modes defined in the 802.11 standard, namely infrastructure network and ad hoc network. For the infrastructure mode, there is an access point (AP); mobile Wi-Fi stations obtain an access point's information through a scan, and then attempt to the access point. For an ad hoc network mode, one station initiates such a network by beaconing (similar to an access point), whereby other stations (peers) detect this network through scanning. A primary difference is that in the infrastructure mode, all stations' traffic first goes to the access point, even for two stations that want to communicate with one another, whereas in ad hoc mode, stations talks directly to each other.

However, consider when there are many mobile device users, and each one has a mobile device that supports Wi-Fi. As users may move in various patterns and/or at various times, they are not necessarily always covered by an access point. At such times, if a device wants to communicate using Wi-Fi, peer discovery is needed.

However, to make a Wi-Fi device discoverable, it has to send out beacon messages so that others can detect those messages. Although this is generally straightforward in that such discovery is generally just a process of sending and receiving messages, for power-constrained mobile devices using Wi-Fi, there are complications. For one, devices that are discoverable to others have to send out beacons, while the devices that want to discover others have to remain awake and scan essentially all the time, so as to detect a beacon. Such message sending, scanning and staying awake consumes a significant amount of power whether Wi-Fi is awake so as to be ready for receiving, or is actively sending/receiving.

Another complication is that in the IEEE 802.11 standard, multiple frequency channels are defined for interference mitigation. For example, in 802.11b, eleven channels are defined and three of them are orthogonal (non-overlapped); while in 801.11a, thirteen orthogonal channels are defined. As an 802.11-based NIC can only operate on one channel at a time, and is awake for receiving or sending, scanning is often required so that peers can discover each other. Typically a NIC will scan a channel for 150 ms, whereby a scan for all eleven channels takes 1.65 seconds; this scanning consumes a great deal of power.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a mobile computing device configured for network communication uses a wakeup pattern to determine when to attempt discovery of another network device. When awake, the device attempts discovery during at least part of the awake time; if unsuccessful the device returns to a non-discovery state that uses less power than when attempting discovery. In one aspect, a time clock is synchronized with an external source, such as a cellular service, a GPS system, or a network to establish the time to awaken.

In one aspect, the pattern is such that as long as two devices are within a maximum time synchronization difference, the two devices will be concurrently awake at least a sufficient amount of time to perform discovery. For further energy savings, the awake time may be divided into active and inactive slots. The active and inactive slots are arranged such that at least one active slot of one device overlaps at least one active slot of the other (peer) device.

In one alternative, further power savings may be accomplished by attempting discovery using a pre-agreed-upon communications channel, which may be based upon pseudo-random number generation. Following successful discovery, communication between devices allows the exchange of another agreed-upon communications channel to use for a future discovery attempt.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing example components in a mobile device for awakening in an energy saving pattern to discover other devices.

FIG. 2 is a representation of a wakeup pattern to handle time differences using overlapped periods.

FIG. 3 is a representation of a time-divided wakeup pattern for saving energy even when imprecise time

FIG. 4 is a representation of an example wakeup pattern in which devices wake up to previously agreed upon channels that may vary over time.

FIG. 5 is a flow diagram showing various steps that may be taken for awakening a device according to a discovery pattern.

FIG. 6 shows an illustrative example of a mobile computing device/environment into which various aspects of the present invention may be incorporated.

### DETAILED DESCRIPTION

Various aspects of the technology described herein are generally directed towards using a wakeup pattern on Wi-Fi devices that conserves energy with respect to discovery of other network devices. The wakeup pattern works even with time inaccuracies (time shift) on mobile devices by allocating a wakeup pattern that works regardless of imprecise time synchronization. Also described is multi-channel support.

While various mobile devices and peer discovery are described as examples, it is understood that these are only non-limiting examples, and that other electronic devices with time clocks and Wi-Fi capabilities may be used. Indeed, the wakeup schemes described herein may be also used for access point discovery. Further, as used herein, “Wi-Fi” refers to any wireless connection technology, including WLAN, WiMax, and so forth. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing, networking and power saving in general.

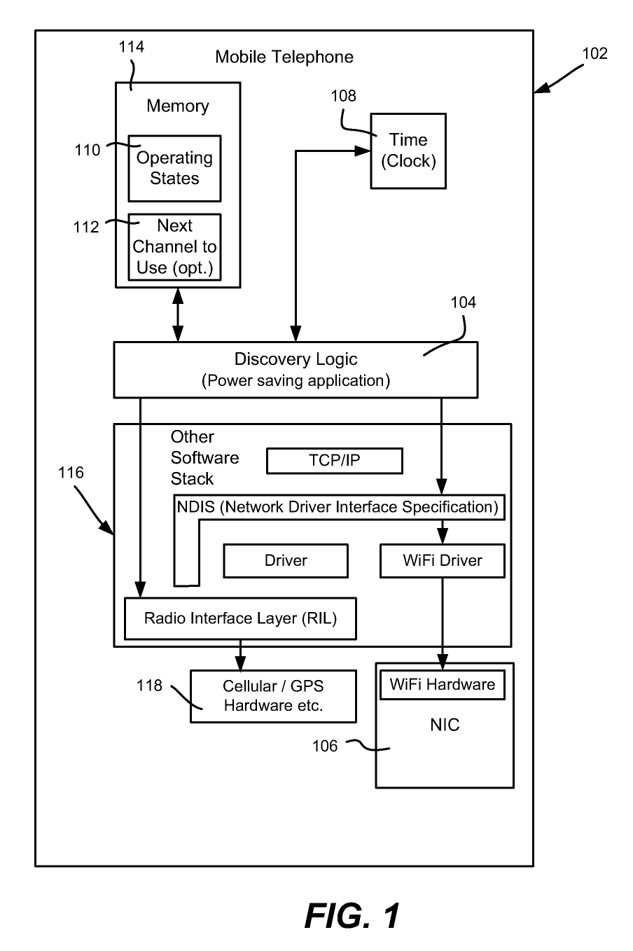

FIG. 1 shows various aspects related to pattern-based Wi-Fi discovery, which significantly reduces the time used for discovery and thereby conserves energy on a mobile device 102 (such as a laptop computer, GPS device or a cellular telephone). In general the mobile device 102 includes scan discovery logic 104 (e.g., a power saving application) that controls when the NIC 106 attempts discovery. As described herein, this is based upon the current time 108 as well as other information (e.g., operating states 110 and/or an optional next channel to use 112) maintained in memory 114. Also shown in FIG. 1 is an example software stack 116 below the discovery logic 104, and hardware 118 that depends on the type of device in use. Among other functionality; such hardware 118 updates the current time 108 as described herein.

A general idea implemented in the logic 104 is to control the time that discovery operations are performed. As described herein, the logic 104 controls the timing such that discovery will occur at a time that is guaranteed to overlap with another device's discovery time, even when the other device is using the same scheme yet the two devices time clocks are not exactly synchronized with one another, that is, the devices have imprecisely synchronized wakeup times.

Turning to aspects of imprecisely synchronized wakeup, each device has a current time, which may be not the same as the time of other devices. However, the maximum time difference among a set of participating devices is known. For example, to obtain the imprecise time, the cellular radio module on a mobile telephone device may be used, as may the GPS time with GPS-enabled mobile devices, and/or a network time when the device opportunistically connects to the Internet.

For mobile devices with a cellular radio, such as a mobile telephone device, the time may be obtained from the cellular tower/cellular service provider. The error of the time from such a service is on the order of a 10 ms granularity. For a mobile device with integrated GPS, accurate time is obtained when outdoors, which time-corrects the device's local clock when more than four satellites are detected. For indoor environments, the cache corrected local clock provides reasonable accurate time, on the order of 10-100 ms granularities.

If the mobile device cannot obtain an accurate time through a cellular service or GPS, an Internet server may be used to correct the device's local clock using NTP (network time protocol). The error of this method is determined by the smallest delay from the device to the server, and on the Internet usually is less than one second.

Note that even without these synchronization mechanisms, the customer may manually adjust the device clock and obtain a time within seconds based on another reasonably correct clock. The power saving mechanisms described herein supports such imprecise time on mobile devices, even at granularities on the order of seconds. As described herein, the times among mobile device are imprecise, although the error range usually is less than second. However, even more imprecise time may be handled. Note that the discovery time for peer discovery is generally much larger than the imprecise time granularity.

In general, there is described herein a wakeup pattern for each device, which occupies two times of the maximum time difference, while sleeping for a rest time. This provides valuable power savings when compared with an unsynchronized wakeup pattern. Also described is the use of a dedicated pseudo-random seed for the devices to select a channel to wake up, thereby supporting multiple channels (as defined by Wi-Fi) instead of a fixed channel which is subjects to interference.

One metric that may be used to compare and evaluate the energy saving processes described herein is power cost ratio, defined as the ratio of the wakeup time to the discovery time. In general, the smallest wakeup time is a time slot, represented as δ, which is used herein as the unit of granularity for the time periods described herein. Note that the smaller the power cost ratio, the more power efficient a device is.

If the various devices (also referred to as nodes) have a synchronized time, then a straightforward solution for saving power with respect to discovery is to let the devices sleep until some prescheduled point in time, at which the various devices wake up and exchange beacons. This may occur for some amount of time before the devices return to their sleep modes. For purposes of explanation, assume that the length of the time period for discovery is Nδ, and that the length of the time period for devices awakening to exchanging beacons is δ. Then 1/N is the power cost ratio relative to an always-awake scheme.

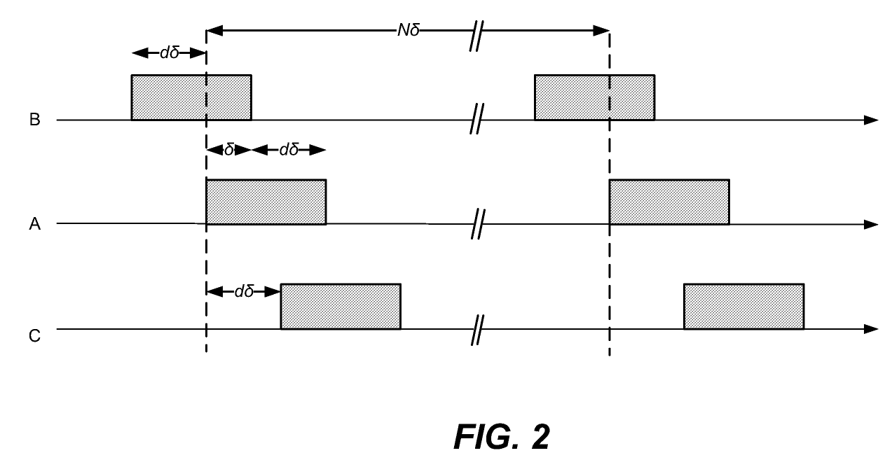

In practice, each device has its own time, but the times may be different between any two devices. However, via various imprecise synchronization mechanisms as described above, the maximal value for any time difference is dδ. As shown in FIG. 2, each device has to wakeup (d+1)δ in order to ensure in the worse case that it still has at least a time length of δ that overlaps with another device's awake time.

By way of the example of FIG. 2, if device A is the one with the slower time, while device B is the one with the faster time, then device A's time is later than B's time by dδ. Thus, device B has to remain awake for (d+1)δ to guarantee that it always has δ time overlapped with the later device A. A similar case happens when device A is has a faster time than a later device C. Thus, when the time is imprecise for the devices and the largest time difference is δ, then each device has to keep awake time (d+1)δ and the power cost ratio is (d+1)/N.

While FIG. 2 demonstrates a reasonable power saving wakeup scheme for discovery among imprecisely synchronized mobile devices, this scheme may be further improved. One reason is that the time difference is much larger than the least overlapped time, i.e., usually d is much larger than 1. For example, in 802.11, a beacon period for in access point (network mode) is 100 ms, so that a 100 ms overlapped time is a reasonable value, i.e., δ=100 ms. However, for time differences on mobile devices, the overlapped time may be as large as 1 second, i.e., d=10. Therefore, the power cost ratio increases tenfold compared to the precisely time-synchronized one. In practice, such an unsynchronized wakeup achieves an energy cost of around 1/\sqrt{N}.

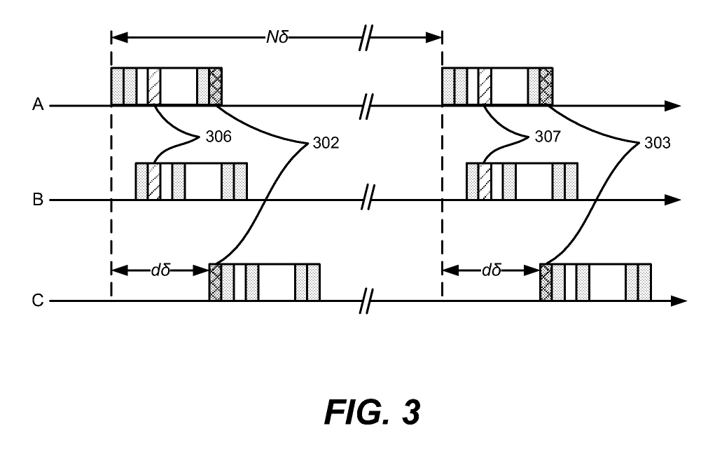

To further reduce the overall awake time and thus reduce the energy cost for the awake time period, an awake pattern is used in which the awake time is divided into slots, and discovery only takes place within certain ones of those slots. More particularly, as exemplified in FIG. 3, the devices does not need to remain awake for the entire time of (d+1)δ to guarantee that it always has a δ time overlapped with any other device. In this example, d=8, with white coloring in the (d+1)δ=9δ time period representing when a device is asleep, and shaded slots representing when a device is awake in that time period.

In this example, assume device A is the device with the fastest time, while device C has the slowest time, so that the difference is dδ. A shaded crisscross pattern 302 or 303 shows that there is an awake time slot in which device A and device C overlap. Similarly via shaded, as shown via slanted patterns 306 and 307, the device B, with a different time somewhere between A and C (e.g., two slots later than device A), has a slot overlapped with A. To this end, the devices only need to keep a pattern of five awake slots instead of all nine slots, (e.g., two on, one off, one on, three off, and two on).

When the time difference of d is considerably smaller than N(d<<N), the devices only need to keep a pattern where \sqrt{2d} slots are awake, whereby the energy cost ratio drops to

$$\frac{\sqrt{2 d}}{N} ;$$

(as d<<N, this ratio is much smaller compared with the synchronized ratio as

$$\frac{1}{\sqrt{N}} = \frac{\sqrt{N}}{N} ) .$$

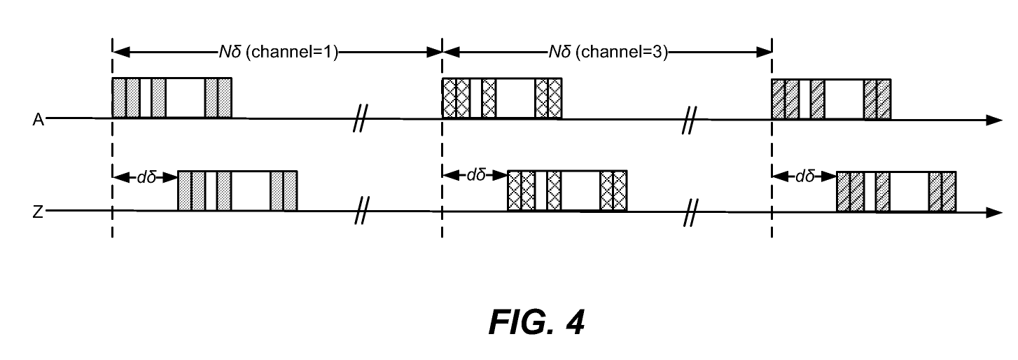

Another aspect is directed towards imprecise synchronized wakeup on multi-channel. As shown in FIG. 4, a pseudo-random code may be used to change the channel every discovery period, i.e., Nδ. The pseudo-random code is shared among the mobile devices so that every device in the same discovery period will select the same channel. In FIG. 4, different shades/patterns are used demonstrate the different channels chosen, with devices A and Z representing the two devices with the largest time difference, as dδ.

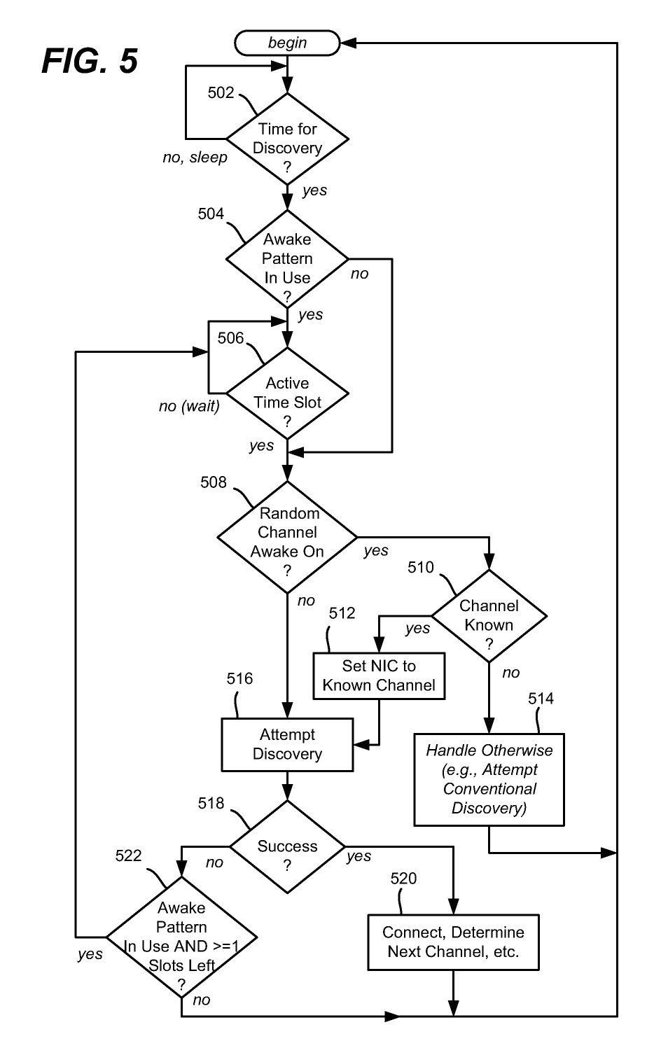

FIG. 5 summarizes some of the logic that may be performed. Note that the steps in FIG. 5 summarize the various options described herein, and may be omitted or modified based upon whether the options are adopted (or specifically not adopted) and are thus no longer optional. For example, if the convention becomes to use the time-slot awake based discovery pattern of FIG. 3, then steps 504 and 506 (and the first part of step 522) will always be yes, whereby there is no need for the logic to evaluate whether time-slots are in use. In any event, the steps of FIG. 5 are only examples.

Step 502 represents determining whether it is time (based on the actual time 108) for the device to awaken and attempt discovery. Until the time is reached, (which may be a triggering event rather than a loop), the device remains asleep with respect to attempting discovery, thereby conserving energy.

If time to awaken, step 504 evaluates whether the slot-based awake pattern (e.g., of FIG. 3) is in use. If not, in this example the process branches ahead to at step 508 to evaluate the next option.

If time slots are in use, step 506 determines whether the current time corresponds to one of the active time slots in the pattern. If not, step 506 waits for the next time slot to begin, although as described above, this may be event driven. Indeed, the entire discovery process may be event driven, e.g., one event fired each active time slot.

When it is time for discovery, step 508 (again, optionally) determines whether the pseudo-random channel mode is on, as described above with reference to FIG. 4. If so, and the channel is known from previous communication, step 510 branches to step 512 to set the channel for discovery. This saves power, as discovery is fast if the channel is agreed upon in advance. If not known, such as if the user has just started communication, step 510 branches to step 514 where other actions are taken, e.g., to attempt conventional always-on discovery for at least a sufficient time to locate any other devices.

Step 516 represents attempting discovery. If successful as evaluated at step 518, the device attempts to connect in a known manner and communicate as desired. Note that one piece of communication, when the pseudo-random channel discovery is on, is to exchange data so that the next channel is known in advance.

If discovery is not successful, there are two possibilities, one of which is that no other discoverable device is within range to be discovered. Another possibility when using awake pattern time-slot based discovery is that no two active time slots have overlapped. If the awake pattern mode is in use, and discovery within the last time slot has not been attempted, then step 522 branches to step 506 to continue to attempt discovery in the next active time slot. If all time slots have been used, (or the awake pattern option is not on), there are no discoverable devices in range, and the device returns to step 502.

As can be seen, using one or more of the above schemes saves power, as discovery is only attempted at controlled times, yet at times that are guaranteed to overlap in normal circumstances regardless of imprecisely synchronized devices. Also, discovery can take place quickly if the channel for discovery is exchanged among devices in advance.

### Exemplary Operating Environment

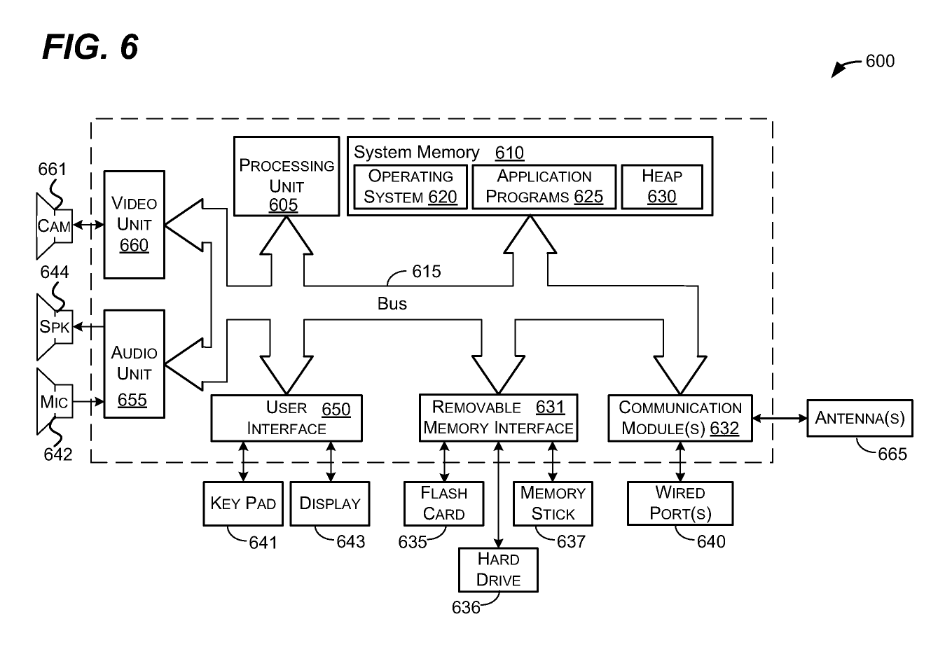

FIG. 6 illustrates an example of a suitable mobile device 600 on which aspects of the subject matter described herein may be implemented. The mobile device 600 is only one example of a device and is not intended to suggest any limitation as to the scope of use or functionality of aspects of the subject matter described herein. Neither should the mobile device 600 be interpreted as having any dependency or requirement relating to any one or combination of components illustrated in the exemplary mobile device 600.

With reference to FIG. 6, an exemplary device for implementing aspects of the subject matter described herein includes a mobile device 600. In some embodiments, the mobile device 600 comprises a cell phone, a handheld device that allows voice communications with others, some other voice communications device, or the like. In these embodiments, the mobile device 600 may be equipped with a camera for taking pictures, although this may not be required in other embodiments. In other embodiments, the mobile device 600 comprises a personal digital assistant (PDA), hand-held gaming device, notebook computer, printer, appliance including a set-top, media center, or other appliance, other mobile devices, or the like. In yet other embodiments, the mobile device 600 may comprise devices that are generally considered non-mobile such as personal computers, servers, or the like.

Components of the mobile device 600 may include, but are not limited to, a processing unit 605, system memory 610, and a bus 615 that couples various system components including the system memory 610 to the processing unit 605. The bus 615 may include any of several types of bus structures including a memory bus, memory controller, a peripheral bus, and a local bus using any of a variety of bus architectures, and the like. The bus 615 allows data to be transmitted between various components of the mobile device 600.

The mobile device 600 may include a variety of computer-readable media. Computer-readable media can be any available media that can be accessed by the mobile device 600 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the mobile device 600.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, Bluetooth®, Wireless USB, infrared, Wi-Fi, WiMAX, and other wireless media. Combinations of any of the above should also be included within the scope of computer-readable media.

The system memory 610 includes computer storage media in the form of volatile and/or nonvolatile memory and may include read only memory (ROM) and random access memory (RAM). On a mobile device such as a cell phone, operating system code 620 is sometimes included in ROM although, in other embodiments, this is not required. Similarly, application programs 625 are often placed in RAM although again, in other embodiments, application programs may be placed in ROM or in other computer-readable memory. The heap 630 provides memory for state associated with the operating system 620 and the application programs 625. For example, the operating system 620 and application programs 625 may store variables and data structures in the heap 630 during their operations.

The mobile device 600 may also include other removable/non-removable, volatile/nonvolatile memory. By way of example, FIG. 6 illustrates a flash card 635, a hard disk drive 636, and a memory stick 637. The hard disk drive 636 may be miniaturized to fit in a memory slot, for example. The mobile device 600 may interface with these types of non-volatile removable memory via a removable memory interface 631, or may be connected via a universal serial bus (USB), IEEE 6394, one or more of the wired port(s) 640, or antenna(s) 665. In these embodiments, the removable memory devices 635-137 may interface with the mobile device via the communications module(s) 632. In some embodiments, not all of these types of memory may be included on a single mobile device. In other embodiments, one or more of these and other types of removable memory may be included on a single mobile device.

In some embodiments, the hard disk drive 636 may be connected in such a way as to be more permanently attached to the mobile device 600. For example, the hard disk drive 636 may be connected to an interface such as parallel advanced technology attachment (PATA), serial advanced technology attachment (SATA) or otherwise, which may be connected to the bus 615. In such embodiments, removing the hard drive may involve removing a cover of the mobile device 600 and removing screws or other fasteners that connect the hard drive 636 to support structures within the mobile device 600.

The removable memory devices 635-637 and their associated computer storage media, discussed above and illustrated in FIG. 6, provide storage of computer-readable instructions, program modules, data structures, and other data for the mobile device 600. For example, the removable memory device or devices 635-637 may store images taken by the mobile device 600, voice recordings, contact information, programs, data for the programs and so forth.

A user may enter commands and information into the mobile device 600 through input devices such as a key pad 641 and the microphone 642. In some embodiments, the display 643 may be touch-sensitive screen and may allow a user to enter commands and information thereon. The key pad 641 and display 643 may be connected to the processing unit 605 through a user input interface 650 that is coupled to the bus 615, but may also be connected by other interface and bus structures, such as the communications module(s) 632 and wired port(s) 640.

A user may communicate with other users via speaking into the microphone 642 and via text messages that are entered on the key pad 641 or a touch sensitive display 643, for example. The audio unit 655 may provide electrical signals to drive the speaker 644 as well as receive and digitize audio signals received from the microphone 642.

The mobile device 600 may include a video unit 660 that provides signals to drive a camera 661. The video unit 660 may also receive images obtained by the camera 661 and provide these images to the processing unit 605 and/or memory included on the mobile device 600. The images obtained by the camera 661 may comprise video, one or more images that do not form a video, or some combination thereof.

The communication module(s) 632 may provide signals to and receive signals from one or more antenna(s) 665. One of the antenna(s) 665 may transmit and receive messages for a cell phone network. Another antenna may transmit and receive Bluetooth® messages. Yet another antenna (or a shared antenna) may transmit and receive network messages via a wireless Ethernet network standard.

In some embodiments, a single antenna may be used to transmit and/or receive messages for more than one type of network. For example, a single antenna may transmit and receive voice and packet messages.

When operated in a networked environment, the mobile device 600 may connect to one or more remote devices. The remote devices may include a personal computer, a server, a router, a network PC, a cell phone, a media playback device, a peer device or other common network node, and typically includes many or all of the elements described above relative to the mobile device 600.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term server is often used herein, it will be recognized that this term may also encompass a client, a set of one or more processes distributed on one or more computers, one or more stand-alone storage devices, a set of one or more other devices, a combination of one or more of the above, and the like.

### Conclusion

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents failing within the spirit and scope of the invention.

What is claimed is:

1. In a mobile computing device configured for network communication, a method comprising, determining, according to a pattern, an awake time when to attempt discovery of another network device, awakening at that awake time, attempting discovery during at least part of the awake time, and if unsuccessful returning to a non-discovery state that uses less power than attempting discovery.

2. The method of claim 1 further comprising, synchronizing a clock with an external source to establish the time to awaken.

3. The method of claim 1 further comprising, providing the pattern with timing based upon a likely maximum time synchronization difference between devices that ensures that any two devices are concurrently awake with respect to discovery, including when respective clocks of each device are imprecisely synchronized with one another.

4. The method of claim 3 wherein providing the pattern comprises dividing the awake time into a plurality of slots that includes active discovery slots and inactive discovery slots, and attempting discovery during one or more active discovery slots and operating in the non-discovery state during the inactive discovery slots.

5. The method of claim 4 wherein the awake time is divided into nine slots, including five active discovery slots, and four inactive discovery slots.

6. The method of claim 5 wherein at least two of the active discovery slots are consecutive and at least three of the inactive discovery slots are consecutive.

7. The method of claim 1 wherein attempting discovery comprises using an agreed-upon communications channel.

8. The method of claim 7 further comprising, connecting to another device following successful discovery, and communicating with the other device to exchange a future agreed-upon communications channel to use for a future discovery attempt.

9. The method of claim 8 further comprising, determining the future agreed-upon communications channel based upon pseudo-random number generation.

10. In a mobile computing device configured for network communication, a system comprising, network hardware that attempts discovery of another device, and logic coupled to a time clock that controls the network hardware to attempt discovery based on current time and a pattern of awake times in which discovery may be attempted and non-awake times when no discovery attempts are made, the pattern such that another device operating the same pattern will be concurrently awake with respect to discovery, including the time clock of the device and the time clock of the other device are imprecisely synchronized with one another.

11. The system of claim 10 further comprising means for synchronizing the time clock with an external source, the external source including a cellular service, a GPS source, or a network source, or any combination of a cellular service, a GPS source, or a network source.

12. The system of claim 10 wherein the awake times are divided into a plurality of active discovery slots and inactive discovery slots, the active discovery slots and inactive discovery slots arranged such that when time clock differences between the device and another devices are within an expected maximum, at least one active discovery slot will overlap with at least one active discovery slot of the other device.

13. The system of claim 10 wherein the logic is coupled to a memory that contains information about a previously agreed-upon communications channel, and wherein the logic controls the network hardware to attempt discovery on that channel.

14. The system of claim 10 wherein during communication with another device, the logic stores information about communications channel for a future discovery attempt.

15. The system of claim 10 wherein the device comprises a mobile computing device, a cellular telephone, or a GPS-enabled device, or any combination of a mobile computing device, a cellular telephone, or a GPS-enabled device, and wherein the network hardware is compatible with at least one 802.11 standard.

16. One or more computer-readable media having computer-executable instructions, which when executed perform steps, comprising:
(a) waiting for a mobile device discovery awake time, the awake time divided into active time slots and inactive time slots;
(b) during the mobile device discovery awake time, determining from current time data whether an active time slot is reached, and if so, attempting discovery of a peer device, and if not, waiting for an active time slot to start;
(c) if discovery is not successful, returning to step (a) if all active time slots for this awake time have been reached, or returning to step (b) if not all active time slots for this awake time have been reached.

17. The one or more computer-readable media of claim 16 wherein the awake time, active time slots and inactive time slots are arranged such that if the peer device is running similar steps (a) through (c), and a time clock synchronization difference between the mobile device and the peer device is within a maximum range, the mobile device and the peer device have at least one concurrent active time slot.

18. The one or more computer-readable media of claim 16 wherein the awake time is divided into five active discovery slots, and four inactive discovery slots, and wherein at least two of the active discovery slots are consecutive and at least three of the inactive discovery slots are consecutive.

19. The one or more computer-readable media of claim 16 wherein attempting discovery of the peer device comprises using a previously agreed-upon communications channel.

20. The one or more computer-readable media of claim 16 having further computer-executable instructions comprising, connecting to the peer device following successful discovery.
